(19) United States
(12) Patent Application Publication
(10) Pub. No.: US 2015/0219274 A1
(43) Pub. Date: Aug. 6, 2015

(54) DEVICE HOLDER

(71) Applicant: Aaron Gregory FIELDS, Nashville, TN (US)

(72) Inventor: Aaron Gregory FIELDS, Nashville, TN (US)

(21) Appl. No.: 14/171,050

(22) Filed: Feb. 3, 2014

(51) Int. Cl. F16M 13/02

(52) U.S. Cl. CPC F16M 13/02

(57) ABSTRACT

A device holder is provided. The device holder may include a mounting element affixed to a body. The body may include a base and a grasping arm joined so as to form an aperture adapted to secure a device therein. The grasping arm may include a plurality of grasping portions disposed to protrude into the aperture. The grasping arm may be biased toward the base so as to exert a gripping force on the device secured between the base and the plurality of grasping portions. A user may place the mounting element onto a mounting surface, and thereby designate a dedicated location that the user can commit to memory. The user may then releasably secure the device within the aperture so as to be secured by the plurality of grasping portions when the device may not be in use.

### BACKGROUND OF THE INVENTION

The present invention relates to electronic device accessories and, more particularly, to a mountable holder used to retain a flash drive to a convenient, accessible location.

Currently, accessories for securing USB flash drives and other external storage devices are designed to be portable, such as a key chain or a lanyard. These options do not allow a user to establish a dedicated location where they can readily store and always find their flash drive.

As can be seen, there is a need for a device that retains a flash drive in a dedicated location when not in use.

### SUMMARY OF THE INVENTION

In one aspect of the present invention, a device holder comprises: a base comprising a mounting side, a gripping side, a joining edge and a distal edge; a grasping arm comprising a joining edge and a distal edge, wherein the joining edges are joined to form an aperture; a mounting element affixed to the mounting side; wherein the grasping arm is biased toward the gripping side so as to exert a gripping force on a device secured between the gripping side and the grasping arm, and wherein the distal edges define an opening to allow access to the aperture.

In another aspect of the present invention, method of securing a device in a dedicated location comprises: providing a device holder comprising: a base comprising a mounting side, a gripping side, a joining edge and a distal edge; a grasping arm comprising a joining edge and a distal edge, wherein the joining edges are joined to form an aperture; a mounting element affixed to the mounting side; wherein the grasping arm is biased toward the gripping side so as to exert a gripping force on a device secured between the gripping side and the grasping arm, and wherein the distal edges define an opening to allow access to the aperture; mounting the mounting element on a surface, and thereby the designating a dedicated location; and securing the device releasably within the aperture.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is an exploded perspective view demonstrating an exemplary embodiment of the present invention shown in use;

FIG. 3 is a section detail view of an exemplary embodiment of the present invention along line 3-3 in FIG. 1; and

FIG. 4 is a perspective view of an exemplary embodiment of the present invention shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a device holder. The device holder may include a mounting element affixed to a body. The body may include a base and a grasping arm joined so as to form an aperture adapted to secure a device therein. The grasping arm may include a plurality of grasping portions disposed to protrude into the aperture. The grasping arm may be biased toward the base so as to exert a gripping force on the device secured between the base and the plurality of grasping portions. A user may place the mounting element onto a mounting surface, and thereby designate a dedicated location that the user can commit to memory. The user may then releasably secure the device within the aperture so as to be secured by the plurality of grasping portions when the device may not be in use.

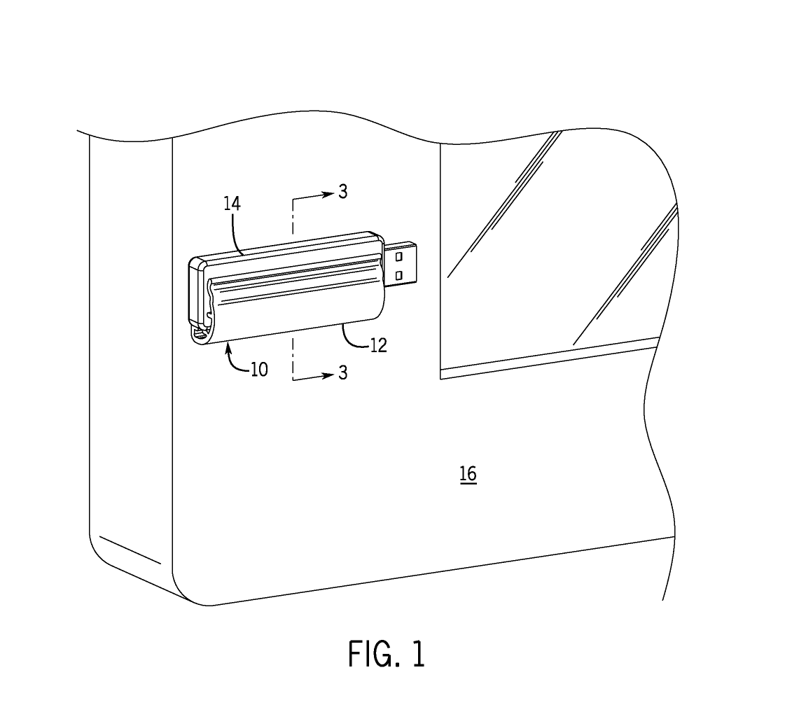

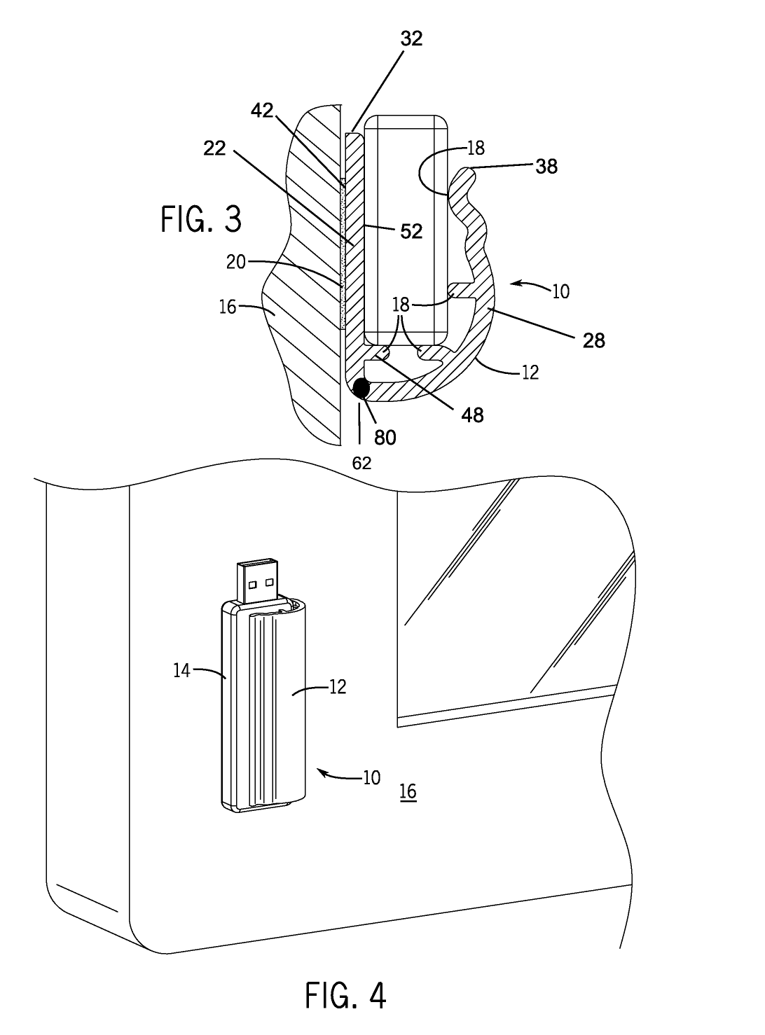

Referring to FIGS. 1 through 4, the present invention may include a device holder 10. The device holder 10 may include a body 12 and a mounting element 20.

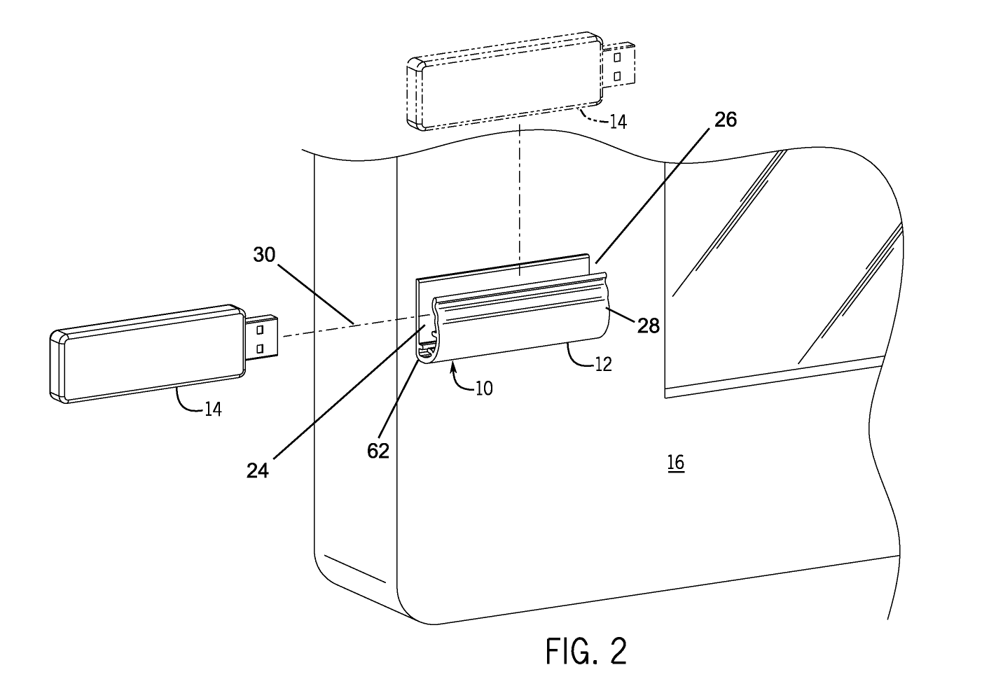

The body 12 may include a base 22 and a grasping arm 28. The body 12 may be formed of a plastic, although any other material that can be repeatedly bent without fracturing, such as polyethylene, polypropylene, vinyl, nylon, various impregnated or laminated fibrous materials, various plasticized materials and the like, may be used as well. The body 12 may be formed by injection molding. The body 12 may have any shape adapted to secure a desired electronic device 14 therein. In certain embodiments, the body 12 may be substantially rectangular, cylindrical, oval, square, triangular or other geometric shape. The device 14 may include a USB flash drive, portable external storage device, a mobile device, web cam, a video and or sound recorder, an electronic device, a motion detector, a sensor and the like. The device holder 10 may be oriented so that the device 14 and the body 12 have their elongated axis 30 generally parallel with respect to each other, as illustrated in FIG. 2.

The base 22 may include a mounting side 42, a gripping side 52, a base joining point 62 and a first end 32. The grasping arm 28 may include a grasping arm joining point 62 and a second end 38. The base 22 and the grasping arm 28 may connect at the joining point 62 so as to form an aperture 24. The aperture 24 may be adapted to secure the device 14 therein. In certain embodiments, the aperture 24 may be sized to secure a USB flash drive. The first end 32 and the second end 38 may define an opening 26 so as to provide access to the aperture 24. The grasping arm 28 may include a plurality of grasping portions 18 disposed to protrude into the aperture 24. In certain embodiments, the gripping side 52 may include at least one grasping portion 18 disposed to protrude into the aperture 24.

The grasping arm 28 may be biased so as to exert a gripping force on the device 14 secured between the gripping side 52 and the plurality of grasping portions 18. The gripping force provided may be of sufficient strength to releasably retain the device 14 absent any bearing support, for example, when the opening 26 is facing downwardly in alignment with gravity. The grasping arm 28 may be adapted to flex sufficiently away from the gripping side 52 to expand the size of the opening 26 and the aperture 24 when inserting the device 14 through the opening 26 and into the aperture 24 so that the device holder 10 may retain an object larger than the aperture 24. The biasing may result from the base 22 being formed of a memory retentive material. In certain embodiments, a spring mechanism 80 may be placed into engagement between the base 22 and the grasping arm 28 to urge the grasping arm 28 toward the gripping side 52 so as to exert gripping force on an inserted device 14. In certain embodiments, the joining point may include the spring mechanism 80.

In certain embodiments, a portion of the plurality of the grasping portions 18 may include at least one bracket 48 on which the device 14 may rest. The at least one bracket 48 may be adapted to prevent the device 14 from being placed too far into the aperture 24.

The mounting element 20 may be affixed to the mounting side 42. The mounting element 20 may be any fastener known in the art for fastening one object to another including, for example, hook and loop fasteners, adhesive substances, combinations thereof, and the like. In certain embodiments, the mounting element 20 may be an adhesive strip with removably liner so as to keep the adhesive strip moist and inapplicable until desired.

A method of using the present invention may include the following. The device holder 10 disclosed above may be provided. A user may place the mounting element 20 of the device holder 10 onto a mounting surface 16, for example a computer and or a computer monitor, and thereby designate a dedicated location that the user can readily access. In certain embodiments, the mounting surface 16 may include drawer, desk, cabinet door, office wall and the like. The user may, in certain embodiments, mount the mounting element 20 on the mounting surface 16 so that the device holder 10 may be oriented in any direction relative to the ground. The user may then releasably secure the device 14 within the aperture 24 so as to be retained by the plurality of grasping portions 18.

It should be understood, of course, that the foregoing relates to exemplary embodiments of the invention and that modifications may be made without departing from the spirit and scope of the invention as set forth in the following claims.

What is claimed is:

1. A device holder comprising:
a base comprising a mounting side, a gripping side and a first end;
a grasping arm comprising a second end, wherein the base and grasping arm are joined forming an aperture;
a mounting element affixed to the mounting side configured to connect the mounting side to a mounting surface;
wherein the grasping arm is biased so as to exert a gripping force on a device secured between the gripping side and the grasping arm, and
wherein the first end and the second end define an opening to allow access to the aperture.

2. The device holder of claim 1, wherein the grasping arm further comprises a plurality of grasping portions protruding into the aperture.

3. The device holder of claim 1, wherein the grasping arm is biased so that it retains an object larger than the aperture.

4. The device holder of claim 1 further comprising a spring mechanism connecting the base and the grasping arm so that the spring mechanism urges the grasping arm toward the gripping side.

5. The device holder of claim 2, wherein the base and the grasping arm are configured to be a unitary construction formed by injection molding.

6. The device holder of claim 5, wherein the base and the grasping arm are formed of a memory retentive material so as to inherently provide the gripping force.

7. A method of securing a device in a dedicated location comprising:
providing a device holder comprising: a base comprising a mounting side, a gripping side, a joining edge and a distal edge; a grasping arm comprising a joining edge and a distal edge, wherein the joining edges are joined to form an aperture; a mounting element affixed to the mounting side; wherein the grasping arm is biased toward the gripping side so as to exert a gripping force on a device secured between the gripping side and the grasping arm, and wherein the distal edges define an opening to allow access to the aperture;
mounting the mounting element on a surface,; and
securing the device releasably within the aperture.

8. The method of claim 6, wherein the grasping arm further comprises a plurality of grasping portions protruding into the aperture.

9. The method of claim 6, wherein the aperture is configured to retain a USB flash drive.

10. The method of claim 6, wherein the surface is a computer.

11. The method of claim 6, wherein the surface is a computer monitor.

12. A device holder comprising:
a base comprising a mounting side, a gripping side and a first end;
a mounting element affixed to the mounting side configured to connect the mounting side to a mounting surface;
a grasping arm comprising a second end and a plurality of grasping portions, wherein the base and grasping arm are joined to form an aperture,
wherein the plurality of grasping portions protrude into the aperture,
wherein the grasping arm is biased so as to exert a gripping force on a device secured between the gripping side and the plurality of grasping portions,
wherein the first end and the second end define an opening to allow access to the aperture, and
wherein the aperture is sized to fit a USB flash drive.

13. The device holder of claim 12, wherein the surface is a computer.
